(19) United States
(12) Patent Application Publication
(10) Pub. No.: US 2023/0338863 A1
(43) Pub. Date: Oct. 26, 2023

(54) WATER SLIDE SEGMENT WITH SPACER LAYER AND METHODS OF MANUFACTURE THEREFOR

(71) Applicant: PROSLIDE TECHNOLOGY INC., Ottawa (CA)

(72) Inventors: Richard Douglas HUNTER, Ottawa (CA); Steven PHILLIPS, Ottawa (CA)

(21) Appl. No.: 17/913,924

(22) PCT Filed: Mar. 30, 2021
(86) PCT No.: PCT/CA2021/050422

§ 371 Date: Sep. 23, 2022

Related U.S. Application Data
(60) Provisional application No. 63/003,530, filed on Apr. 1, 2020.

(51) Int. Cl. A63G 21/18; B29C 70/24

(52) U.S. Cl. CPC A63G 21/18; B29C 70/24

(57) ABSTRACT

A curved water slide segment is disclosed. The segment has a plurality of laminated layers with an outer fiber composite layer, an inner fiber composite layer and a spacer layer positioned between the outer and inner fiber composite layers. The spacer layer defines one or more thermally insulating pockets.

### FIELD

This application relates generally to segments of water slides and, more specifically, water slide segments comprising a spacer layer.

### BACKGROUND

In conventional water-based amusement rides, such as large-scale water slides featured at amusement parks, patrons enter the ride at a high elevation and travel to a terminal destination at a lower elevation by sliding along a chute or flume. To facilitate sliding, portions of a water slide may be lubricated with a volume of water.

Depending on the configuration of a ride, patrons ride directly on the sliding surface of the slide or are carried by a vehicle. Some such vehicles include mats, tubes and boats.

Water slides are typically comprised of segments with a desired geometry that are connected to form the entire slide or a significant portion of the slide between the start and end. Typically, such segments are constructed from fiber-reinforced polymers (FRPs), usually resin impregnated fiberglass, which permits the manufacturer to create a desired geometry while providing sufficient strength and rigidity for use in the water slide.

In some installations, portions of or entire flumes of water slides are outdoors and exposed to temperatures significantly lower than inside the flume, requiring that the portion of the flume outdoors is insulated to reduce heat loss and unpleasant temperatures for riders in bathing attire. Typical insulation consists of foam insulation, such as polyurethane foam, or similar materials that are sprayed on to the outside of the flume. Such foam installation may be undesirable as it is relatively expensive, must be applied on site, inhibits access to the bolts used to connect segments unless appropriate precautions are taken, results in a poor cosmetic appearance, and is not compatible with a desire to have segments be translucent.

Thus, there is a desire to improve the properties of water slide segments, including their insulative properties and structural properties.

### SUMMARY

According to some embodiments of the present disclosure, there is provided a curved water slide segment, the segment having a plurality of laminated layers comprising an outer fiber composite layer, an inner fiber composite layer and a spacer layer positioned between the outer and inner fiber composite layers, the spacer layer defining one or more thermally insulating pockets.

According to some embodiments of the present disclosure, there is provided a method of manufacturing a water slide segment, the method comprising: providing a curved open mould for the segment; applying a first fiber composite layer to the mould; applying a spacer layer to the first fiber composite layer; and applying a second fiber composite layer to the spacer layer.

### BRIEF DESCRIPTION OF THE DRAWINGS

The foregoing summary, as well as the following detailed description of illustrative embodiments of the present application, will be better understood when read in conjunction with the appended drawings. For the purposes of illustrating the present application, there is shown in the drawings illustrative embodiments of the disclosure. It should be understood, however, that the application is not limited to the precise arrangements and instrumentalities shown. In the drawings:

FIG. 1 is an example of a portion of a water slide flume showing segments according to embodiments of the present disclosure;

FIG. 2 is a schematic cross-section of an embodiment of a water slide segment according to the present disclosure;

FIG. 3 shows an exemplary fabric used to create the spacer layer of segments according to embodiments of the present disclosure;

FIG. 4 is a cross-section of a water slide segment incorporating the fabric of FIG. 3;

FIG. 5 shows steps in a method of manufacturing a water slide segment according to embodiments of the present disclosure;

FIG. 6 shows part of an exemplary open mould lay up method for manufacturing a water slide segment according to embodiments of the present disclosure;

FIG. 7 shows a further part of the exemplary method of FIG. 6; and

FIG. 8 shows a further part of the exemplary method of FIG. 6.

### DETAILED DESCRIPTION

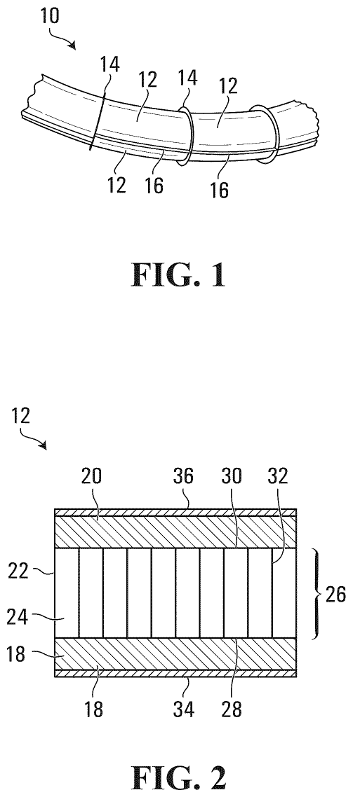

FIG. 1 shows one embodiment of a portion of a flume tube 10 that forms part of a water slide (not shown). The tube 10 is composed of a plurality of water slide segments 12 having varying geometry. The segments 12 are connected end-to-end via end flanges 14 and longitudinally along flanges 16 to form the complete tube.

The tube 10 and segments 12 are exemplary only and a vast variety of segments, with different geometries, may be manufactured and used to create a desired chute, flume, tube, slide and ride. Such segments may or may not be connected to each other via flanges. The principles and embodiments of the present disclosure are applicable to such a vast variety of segments used to create water slides and not only those embodiments shown in the drawings.

In particular, while the principles of the present disclosure may be applied to water slide segments of varying geometry, embodiments of the present disclosure may be particularly suited for curved water slide segments, i.e. water slide segments comprising a curvature. In this context, curved water slide segments are to be understood as water slide segments that are not completely planar and that have geometries incorporating curvatures around at least one axis, such as single curved segments (cylindrical, conical, frusto-conical, etc.), double curved segments (spherical, paraboloid, etc.), complex and compound curved water slide segments, and water slide segments having geometries incorporating curvatures that then transition to planar portions. The example water slide segments 12 of FIG. 1 are considered curved water slide segments.

FIG. 2 is a schematic view of a cross-section of a portion of a water slide segment according to embodiments of the present disclosure, such as the segments 12. The segment includes a plurality of layers, which are laminated together, including a first or outer fiber composite layer 18, a second or inner fiber composite layer 20 and a spacer layer 22 positioned between the outer and inner fiber composite layers 18, 20. The spacer layer 22 defines one or more pockets or voids 24.

In some embodiments, the layers 18, 20 may each comprise multiple individual layers that have been applied and layered together during manufacturing to form a thicker layer since a desired thickness of layer may not be achievable with a single application.

The fiberglass layers 18, 20 comprise chopped fiberglass impregnated with resin, such as polyester resin. In some embodiments, the spacer layer 22 comprises a resin-impregnated fabric 26, such as a woven fabric. The fabric 26 comprises first and second woven cloths 28, 30 separated by resilient pile threads 32 that, after curing, structurally support and maintain the space between cloths 28, 30 and, thus, fiberglass layers 18, 20. The pile threads 32 define the pockets 24. In some embodiments, the fabric 26 is woven from fiberglass threads and impregnated with the same resin used in the fiber composite layers 18, 20, further aiding the structural integrity of the spacer layer. In some embodiments, such as the illustrated embodiment, the pile threads 32 are oriented lengthwise in rows.

Embodiments utilizing a fabric 26 as the spacer layer 22 may be particularly suited to curved geometries of the water slide segment since fabrics may be sufficiently pliable to conform to curved geometries. As such, in some embodiments, the spacer layer is conformable to desired curved geometries.

The resin used to impregnate the layers 18, 20 and the fabric 26 may depend on the desired application. For example, in some embodiments, the resin may be a translucent resin. In such embodiments, after impregnation, the layers 18, 20 and fabric 26 maintain a degree of translucency, allowing for an insulated and partially or fully translucent water slide segment. In other embodiments, an opaque resin may be used.

In the illustrated embodiment, the segment 12 further comprises outer and inner gel coat layers 34, 36. The outer gel coat layer 34 is applied to an outer side of the outer fiber composite layer 18. The gel coat layer 34 provides a smooth finish and protective and water-resistant surface to the fiber composite layer 18. Similarly, gel coat layer 36 provides a smooth finish and protective and water-resistant surface to the inner fiber composite layer 20. Moreover, when the layer 20 forms part of a sliding surface of the segment 12, the gel coat layer 36 provides a smooth riding surface for the rider or ride vehicles.

The laminate construction described in FIG. 2 provides insulative properties to the segment 12. Specifically, the pockets 24 act as thermal insulation between the fiber composite layers 18, 20. For example, in some embodiments, when the pockets are filled with ambient air, the thermal conductivity of the spacer layer may be 0.08 W/mK or less, in particular 0.06 W/mK or less. Similarly, the thermal resistance (RSI) value of the spacer layer may be in the range of 0.05 to 0.28 m²K/W.

In some embodiments, light effects may be incorporated into the segment by utilizing the translucent properties of the segment 12. For example, the fabric 26 and fiber composite layers 18, 20, may be impregnated with translucent resin, while opaque, less translucent and/or coloured gel coats are used in different regions of the segment. This may cause a rider within the segment to perceive light effects as different amounts of external light pass through the different regions of the gel coat. For example, in this manner, a rider may experience circumferential bands of coloured light while travelling through tube 10. According to principles of the present disclosure, it is possible to permit and incorporate such light effects in segments that also have thermal insulation. Prior, known solutions for thermally insulating segments would prevent incorporation of such light effects by blocking external light from passing into the segment, such as spray foam insulation on the exterior of segments.

In some embodiments, the thermal resistance (i.e. RSI and R-value) may be further increased by drawing a partial vacuum in the pockets 24; replacing part or all of the air in the pockets 24 with an inert, insulating gas, such as argon; and/or filling part or all of the space between the layers 18, 20 with an injectable spray foam.

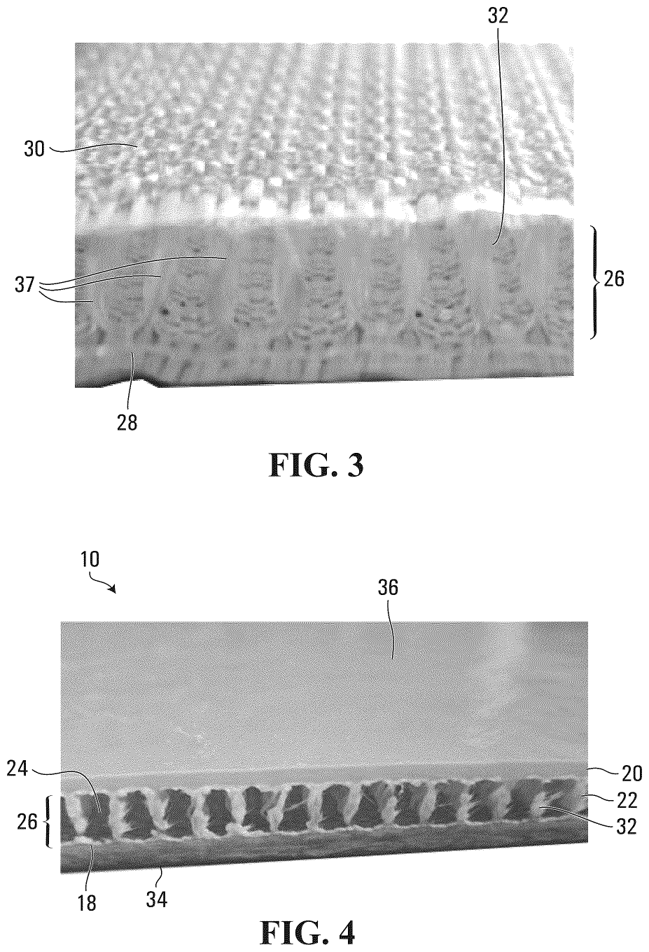

FIG. 3 is a photograph of a cross-section of one possible fabric to be used as the fabric 26 prior to impregnation with resin. In some embodiments, the fabric 26 may comprise glass fiber fabrics sold under the name PARABEAM®. Each of woven layers 28, 30 sandwich pile threads 32 that are arranged in rows 37 parallel to the warp direction of the warp threads in each of layers 28, 30.

FIG. 4 depicts an example cross-section of a water slide segment 12, incorporating the fabric of FIG. 3 in the spacer layer 22, following lamination and curing. In some embodiments, the fabric used may range in thickness from 4 mm to 30 mm. In some embodiments, the areal weight of the fabric may be in the range from 700 g/m³ to 2000 g/m³.

In yet other embodiments, the spacer layer may comprise one or more structural components that is layered between the fiber composite layers 18, 20. Such structural components could include a tessellated pattern of cells and/or structures including walls, pillars, columns, or other features to maintain a distance between fiber composite layers 18, 20 and define pockets 24. In yet other embodiments, the spacer layer may be provided by manufacturing the fiber composite layers 18, 20 separately with complementary geometries and joining them together with mechanical spacers to create the pockets 24.

Water slide segments according to the present disclosure may be manufactured in a variety of ways. One such method may involve an open moulding process, also known as spray layup or hand layup process.

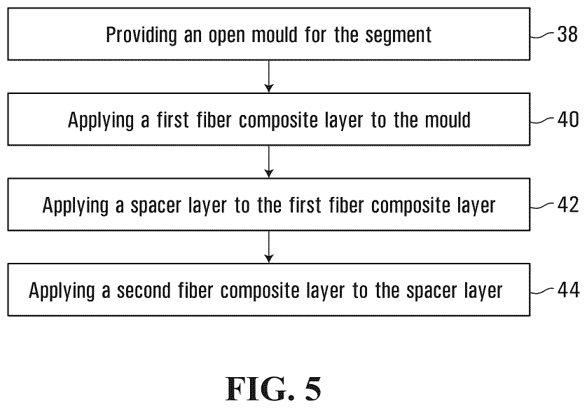

Referring to FIG. 5, one embodiment of a method for manufacturing a water slide segment will be described. The method includes providing an open mould for the segment at 38, applying a first fiber composite layer to the mould at 40, applying a spacer layer to the first fiber composite layer at 42, and applying a second fiber composite layer to the spacer layer at 44.

It will be understood that the mould provided to manufacture the water slide segment defines a geometry of the water slide segment and comprises a complementary geometry to the desired geometry of the water slide segment. As seen in FIG. 5, a curved open mould may be provided in order to provide for a curved water slide segment.

In some embodiments, the first fiber composite layer may comprise multiple layer applications that have been built up to form the first layer. How many individual layer applications are needed to form the first fiber composite layer may depend on the desired segment geometry, the desired structural integrity, etc. Similarly, the second fiber composite layer may comprise multiple layer applications.

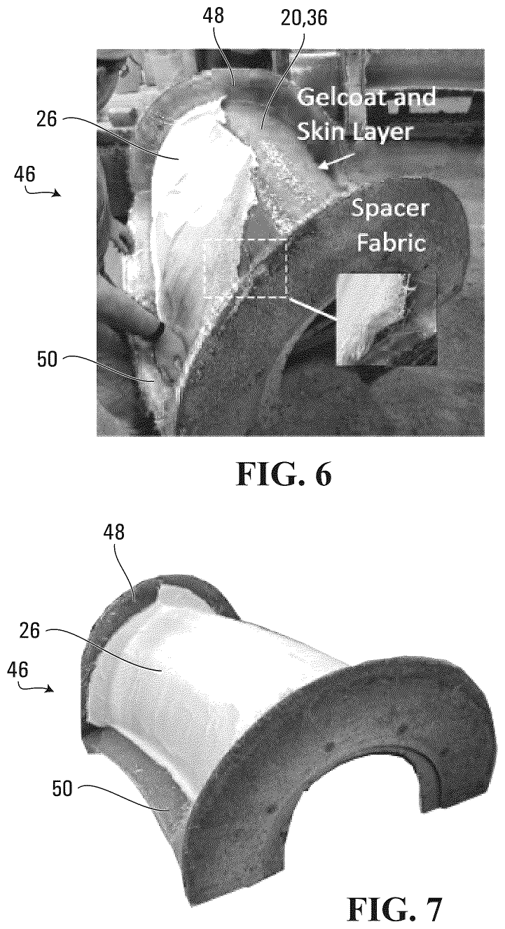

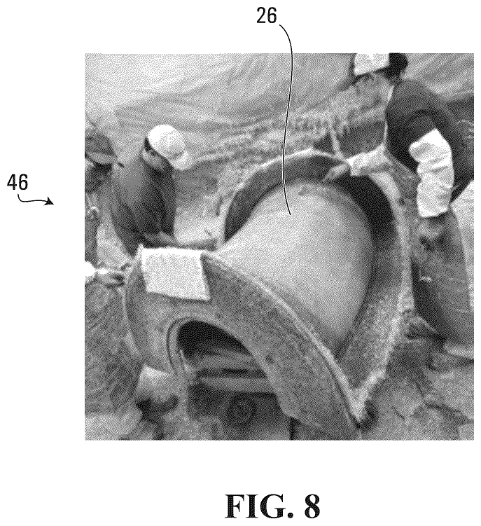

FIGS. 6-8 show stages of a hand layup manufacturing process and method according to embodiments of the invention. FIG. 6 shows a mould 46 for a water slide segment, such as one of the segments 12. The mould 46 includes a curved surface 48 to which a gel coat and first fiber composite layer (sometimes known as a skin layer), such as the gel coat 36 and fiber composite layer 20, have been applied. The mould 46 includes end mould flanges 48 and longitudinal mould flanges 50 used to mould flanges 14 and 16, respectively. A spacer layer is in the process of being applied. In the illustrated embodiment, the spacer layer comprises a spacer fabric, such as the fabric 26. The characteristics of the spacer fabric, such as its pliability, permit the fabric to be draped and conformed to the desired curvature of the mould. FIG. 7 depicts the mould 46 with the fabric 26 fully applied. FIG. 8 depicts the process of manual impregnation, saturation and consolidation of the fabric 26 with resin.

As noted above, the fabric 26 may have resilient properties such that, during impregnation and saturation of the fabric, the fabric is compressed and then resiliently assume substantially the same thickness it had prior to impregnation and consolidation. The resiliency of the fabric may be provided, inter alia, by the configuration and resiliency of pile threads 32. During the curing phase after consolidation as the fabric substantially resumes its original thickness, pockets, such as the pockets 24 are formed. Following curing of the saturated spacer layer 22 and application of the second fiber composite layer, a further outer gel coat layer (not shown) may be applied.

The inventive concepts disclosed herein are not limited in their application to the details of construction and the arrangement of the components set forth in the description or illustrated in the drawings. The inventive concepts disclosed herein are capable of other embodiments or of being practiced or carried out in various ways. Also, it is to be understood that the phraseology and terminology employed herein is for the purpose of description and should not be regarded as limiting the inventive concepts disclosed and claimed herein in any way.

For example, in addition to insulative properties provided by the spacer layer, some embodiments of the spacer layer provide additional improved structural properties as compared to fiber composite segments known from the prior art. For example, a segment having an 8 mm thick spacer layer comprising the fabric described above in respect of FIG. 3 with 2.5 mm thick fiber glass layers 18, 22 has a bending rigidity of approximately 1255 Nm²/m, as compared to 127 Nm²/m for a prior art segment with similar geometry.

Furthermore, in some embodiments, the orientation of the applied spacer fabric may be configured to improve structural properties in a desired direction or directions of the segment 12. The impregnated and cured fabrics have an improved structural rigidity particularly in a direction parallel to the lengthwise orientation of the rows of pile threads. Thus, during application of the spacer fabric, the fabric may be applied so that the rows of pile threads are oriented in one or more directions in which improved mechanical properties of the segment are desired, for example improved stiffness and strength. Thus, in some embodiments, the rows of pile threads may be oriented longitudinally from end to end of the segment.

Alternatively, in some embodiments, the spacer fabric may be configured to have pile threads arranged in more than one direction to provide for a multi-directional improvement in structural properties. In yet other embodiments, multiple layers of the fabric may be used, with each layer having pile threads of different orientations. In particular, an open mould lay up process as described herein may be beneficial in permitting multiple layers of fabric or spacer to be used without compromising the thickness of either of the fiber composite layers that sandwich the spacer layer therebetween.

Numerous specific details have been set forth in order to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having” or any other variation thereof, are intended to cover a nonexclusive inclusion. For example, a composition, a process, method, article, or apparatus that comprises a list of elements is not necessarily limited to only those elements but may include other elements not expressly listed or inherently present therein.

As used herein the terms “approximately,” “about,” “substantially” and variations thereof are intended to include not only the exact value qualified by the term, but to also include some slight deviations therefrom, such as deviations caused by measuring error, manufacturing tolerances, wear and tear on components or structures, stress exerted on structures, and combinations thereof, for example.

Use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Moreover, it will be understood that features of one embodiment may be combined with features of other embodiments, even if not expressly recited or described as a combination.

1. A curved water slide segment, the segment having a plurality of laminated layers comprising an outer fiber composite layer, an inner fiber composite layer and a spacer layer positioned between the outer and inner fiber composite layers, the spacer layer defining one or more thermally insulating pockets.

2. The segment of claim 1, wherein the spacer layer comprises a resin-impregnated fabric.

3. The segment of claim 2, wherein the fabric comprises first and second woven cloths separated by resilient pile threads.

4. The segment of claim 2, wherein the fiber composite layers and fabric are impregnated with an opaque resin.

5. The segment of claim 2, wherein the fiber composite layers and fabric are impregnated with a translucent resin.

6. The segment of claim 2, wherein the fabric comprises fiberglass threads.

7. The segment of claim 1, wherein the spacer layer comprises a resin-impregnated resilient material.

8. The segment of claim 1, further comprising an outer gel coat applied to the outer fiber composite layer on a side of the outer fiber composite layer opposite the spacer layer.

9. The segment of claim 1, further comprising an inner gel coat applied to the inner fiber composite layer on a side of the inner fiber composite layer opposite the spacer layer.

10. The segment of claim 1, wherein the inner fiber composite layer defines a portion of a sliding surface of a water slide.

11. The segment of claim 1, wherein the spacer layer provides a thermal conductivity of 0.06 W/mK or less.

12. The segment of claim 3, wherein the pile threads are arranged in rows and the fabric is arranged to increase stiffness and/or strength of the segment in the direction of the of the rows.

13. A method of manufacturing a water slide segment, the method comprising:
providing a curved open mould for the segment;
applying a first fiber composite layer to the mould;
applying a spacer layer to the first fiber composite layer; and
applying a second fiber composite layer to the spacer layer.

14. The method of claim 13, wherein applying the spacer layer comprises applying a fabric, impregnating the fabric with resin and allowing the impregnated fabric to cure.

15. The method of claim 14, wherein applying the spacer layer comprises compressing the fabric during impregnation and allowing the impregnated fabric to resiliently return to a thickness substantially similar to a thickness prior to impregnation.

16. The method of claim 13, further comprising applying a gel coat to the mould prior to applying the first fiber composite layer.

17. The method of claim 13, further comprising applying a gel coat to the second fiber composite layer.

18. The method of claim 13, wherein applying the spacer layer comprises forming one or more thermally insulating pockets.

19. The method of claim 14, wherein applying the fabric comprises arranging the fabric so as to increase stiffness and/or strength of the segment in a desired direction.
